(19) United States
(12) Patent Application Publication
(10) Pub. No.: US 2024/0186649 A1
(43) Pub. Date: Jun. 6, 2024

(54) BATTERY THERMAL RUNAWAY MANAGEMENT

(71) Applicant: Zimeno Inc., Livermore, CA (US)

(72) Inventors: Kern Rameshwar SHARMA, Foster City, CA (US); Alen ANTONY, Pleasanton, CA (US); Karansinh Mangesh KURANE, Dublin, CA (US); Andre Pereira BOJIKIAN, Walnut Creek, CA (US)

(73) Assignee: Zimeno Inc., Livermore, CA (US)

(21) Appl. No.: 18/516,819

(22) Filed: Nov. 21, 2023

Related U.S. Application Data
(60) Provisional application No. 63/429,154, filed on Dec. 1, 2022.

(51) Int. Cl. H01M 50/383; H01M 50/209; H01M 50/24

(52) U.S. Cl. CPC H01M 50/383; H01M 50/209; H01M 50/24; H01M 2220/20

(57) ABSTRACT

A battery runaway management system includes at least one battery module and a cover. The cover extends over a top and each side of the at least one battery module. The cover is integrally formed as a single unitary body from a fire-resistant or fire-retardant material.

### CROSS-REFERENCE TO RELATED APPLICATIONS

The present non-provisional application claims priority from co-pending U.S. provisional patent Application Ser. No. 63/429,154 filed on Dec. 1, 2022, by Sharma et al. and entitled BATTERY THERMAL RUNAWAY MANAGEMENT, the full disclosure of which is hereby incorporated by reference.

### BACKGROUND

Electrically powered vehicles may rely upon a relatively large bank of individual battery modules to supply sufficient power for propelling the vehicle and for operating various functions of the vehicle. Examples of electrically powered vehicles include, but are not limited to, agricultural equipment, such as tractors, harvesters and the like, automobiles, trucks, and construction equipment. During their use, the battery modules may generate large amounts of heat.

### BRIEF DESCRIPTION OF THE DRAWINGS

FIG. 1 is a perspective view of an example electrically powered vehicle.

FIG. 2 is a fragmentary perspective view of the example electrically powered vehicle of FIG. 1 illustrating an example bank of battery modules.

FIG. 3 is a perspective view illustrating the example bank of battery modules of FIG. 2.

FIG. 4 is a top view illustrating an example battery module cover panel prior to being shaped.

FIG. 5 is a perspective view illustrating the example battery module cover following shaping of the battery module cover panel of FIG. 4.

FIG. 6 is a perspective view illustrating the example battery module cover of FIG. 5 about an example battery module.

FIG. 7 is a sectional view of the battery module cover and covered battery module of FIG. 6 taken along line 7-7, with additional fire-resistant foam layers.

FIG. 8 is a sectional view of an example bank of example battery modules with the example battery module covers and fire-resistant foam layers of FIG. 7.

FIG. 9 is a perspective view of an example bank of battery modules and example battery module covers with example fire resistant foam layers.

FIG. 10 is a top view illustrating an example battery module cover panel prior to being shaped.

FIG. 11 is a perspective view illustrating the example battery module cover panel during shaping.

FIG. 12 is a perspective view of an example battery module cover following shaping of the battery module cover panel of FIG. 10.

FIG. 13 is a sectional view illustrating an alternative battery module cover taken along line 13-13 of the battery module cover of FIG. 12.

FIG. 14 is a perspective view illustrating portions of an example bank of battery modules and battery module covers of FIG. 12 prior to provision of fire-resistant foam layers.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description; however, the description is not limited to the examples and/or implementations provided in the drawings.

### DETAILED DESCRIPTION OF EXAMPLES

Disclosed are example battery thermal runaway management systems that may increase the safety of an electrical vehicle by providing a mechanism for delaying or slowing down the spread of any fire that might result from overheating of the battery modules. The example battery thermal runaway management systems delay the spread of a fire from one battery module to another to provide an operator a greater amount of time to safely exit the electrically powered vehicle.

For purposes of this disclosure, the term “coupled” shall mean the joining of two members directly or indirectly to one another. Such joining may be stationary in nature or movable in nature. Such joining may be achieved with the two members, or the two members and any additional intermediate members being integrally formed as a single unitary body with one another or with the two members or the two members and any additional intermediate member being attached to one another. Such joining may be permanent in nature or alternatively may be removable or releasable in nature.

For purposes of this disclosure, the phrase “configured to” denotes an actual state of configuration that fundamentally ties the stated function/use to the physical characteristics of the feature proceeding the phrase “configured to”.

Throughout the disclosure the terms “fire resistant” and “fire retardant” are used interchangeably. Such terms refer to the ability of the material to resist catching fire and/or to resist structural failure or damage in response to high temperatures and/or the presence of a fire. In some implementations, the fire-resistant or fire-retardant material is configured to withstand a temperature of at least 750° C. for at least 10 minutes. In some implementations, the fire-resistant or fire-retardant material is configured to withstand a temperature of 1200° C. for at least 10 minutes. One example of such fire resistant or fire-retardant material is mica. In some implementations, mica particulates are provided throughout a resin, facilitating bending or deformation of a panel formed from a mica particulates and resin. In other implementations, other fire retardant or fire-resistant particulates may be encapsulated with a resin. In other implementations, other fire retardant or fire-resistant materials may be utilized in the battery module covers.

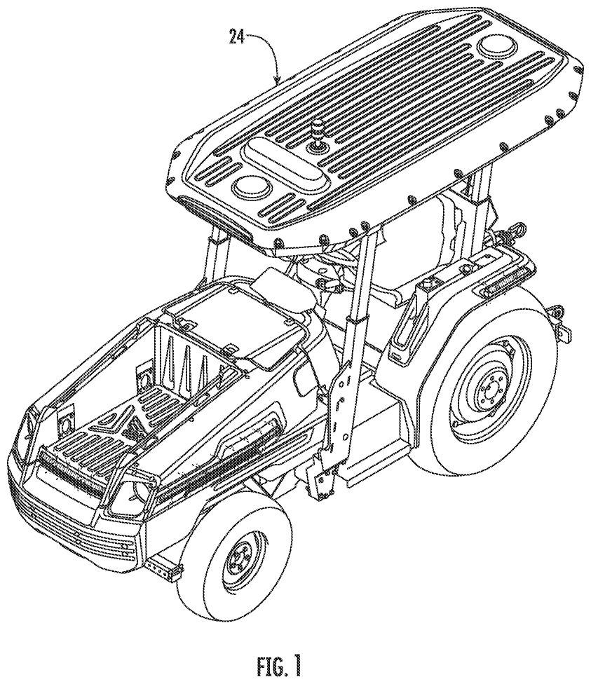

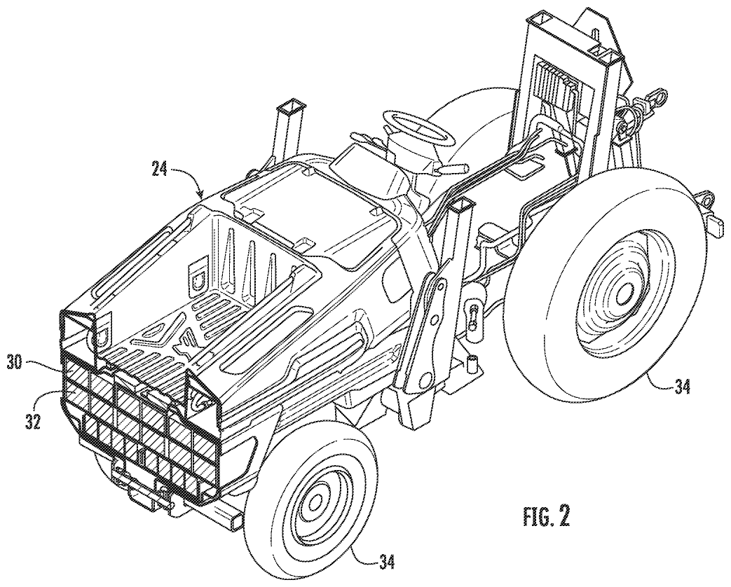

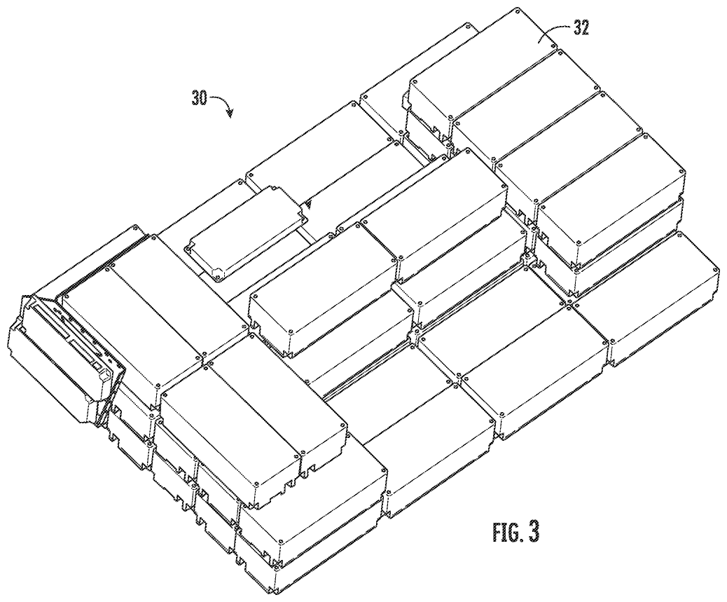

FIG. 1 is a perspective view illustrating an example electrically powered vehicle in the form of a tractor 24. As shown by FIG. 2, tractor 24 houses a bank 30 of battery modules 32. Battery modules 32 supply electrical power for propelling or driving the ground engaging members 34 (wheels). FIG. 3 illustrates an example bank 30 of battery modules 32, wherein each of the battery modules 32 may be at least partially covered by a fire-resistant cover and layers of a fire-resistant material, such as a fire-resistant foam.

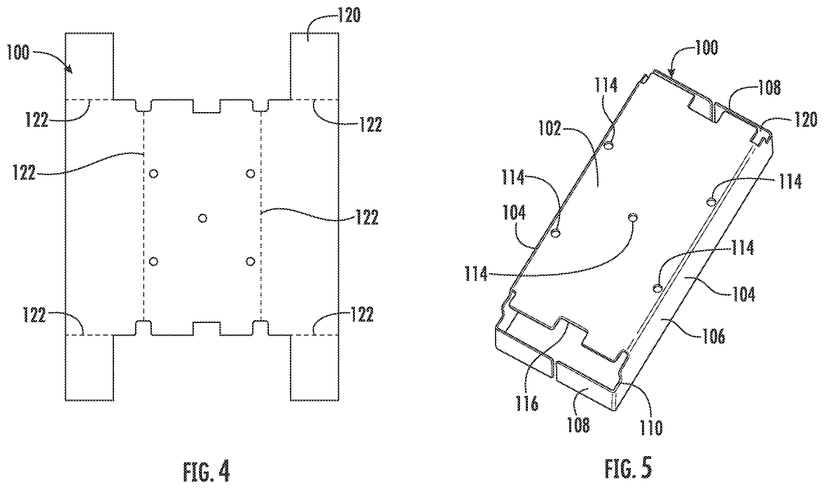

FIG. 4 and FIG. 5 illustrate the forming of an example cover for an individual battery module. In the example illustrated, cover 100 is configured to extend over a top and each side of an individual battery module 32. Cover 100 is integrally formed as a single unitary body from a fire-resistant material. In one implementation, the fire-resistant material comprises mica. In some implementations, the mica may comprise a flexible mica such as Phlogopite Mica. In some implementations, the fire-resistant material comprises mica particulates encapsulated within a resin, such as a heat resistant lower thermal conductivity polyurethane foam. The mica barrier works well for deflecting streaming hot gases venting from a top or sides of the battery modules. If such gases are not adequately deflected, the gas may punch a hole into the overhead metallic (aluminum) tray above the compromise module and may set the modules on a thermal runaway. In some implementations, the fire-resistant material is configured to withstand a temperature of at least 750° C. for at least 10 minutes. In some implementations, the fire-resistant material is configured to withstand a temperature of 1200° C. for at least 10 minutes.

As shown by FIG. 5, cover 100 comprises a cover top 102 and four cover sides 104 which includes side walls 106 and end walls 108. At least one of an walls 108 has an opening 110 through which a portion of the battery module 32 may project. The projecting portion of the battery module may comprise a battery connection interface. As further shown by FIG. 5, the cover top 102 may include fill ports 114 through which a fire-resistant expanding foam may be injected between the cover 100 and the underlying battery module 32.

As shown by FIG. 4, in the example illustrated, cover 100 comprises a single flat panel 120 of fire-resistant material that is bent to form the cover top 102 and the four cover sides 104. In some implementations, the single flat panel 120 has a thickness of at least 1.0 mm and no greater than 1.75 mm. The thickness of panel 120 is sufficiently thin to facilitate bending or shaping of the panel to form the cover. Moreover, the thickness is sufficiently thin so as to maintain the compact nature of the larger pack of battery modules where battery models may be stacked, facilitating a sufficient number of battery modules or a sufficiently sized pack of battery modules to adequately provide power for propelling vehicle 24 over prolonged durations. At the same time, the thickness of panel 120 is sufficiently large to provide sufficient fire resistant or fire-retardant properties. In yet other in a where panel 120 may be formed from other fire resistant or fire-retardant materials panel 120 may have other thicknesses.

In some implementations, the panel 120 may be provided with preformed creases 122 about which panel 120 may be bent and folded to form the cover top 102 and the four cover sides 104. Because cover 100 is formed from a single panel 120, cover 100 involves less assembly and may be more robust. Because cover 100 is formed from a bendable panel of fire-resistant material, prior to being bent, cover panel 100 may be more easily stacked and shipped or transported as well as more easily stored. The flattened nature increases volumetric efficiency of shipping, saving cost. In other implementations, cover 100 may be formed in other fashions, other than bending. For example, cover 100 may be formed by molding extrusions and the like. In some implementations, cover 100 may include portions that are bent and portions that are bonded, fused, welded or otherwise joined to the bent portions of cover 100.

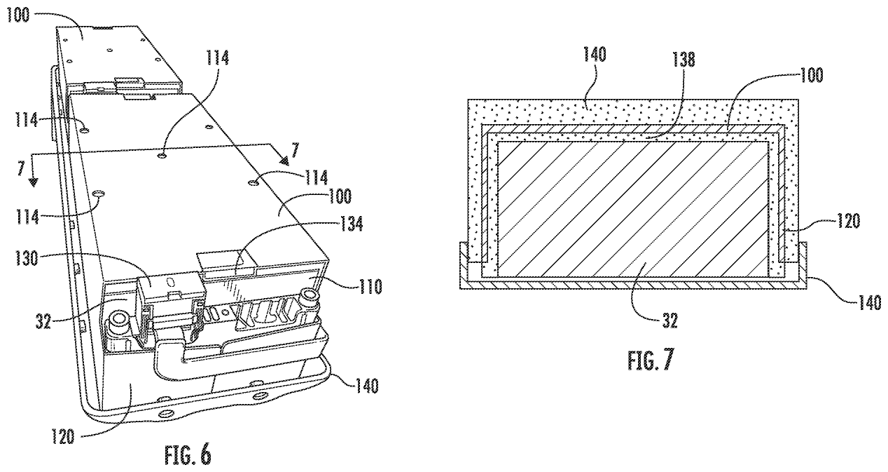

FIG. 6 is a perspective view illustrating cover 100 overlying and extending about a battery module 32 with a connection interface 130 of the battery module 32 projecting through opening 110. In the example illustrated, the cover top 102 further comprises a notch, cutout or opening 116 which facilitates access to an additional connection interface 134 of battery module 32. As further shown by FIG. 6, the battery module 32 rests within an underlying metallic tray or pan 140. The pan 140 may receive a single battery module 32 or multiple battery modules 32 along with their associated covers 100.

FIG. 7 is a sectional view taken along line 7-7 of FIG. 6. FIG. 7 illustrates the addition of an injected foam 138 through fill ports 114 into the space between battery module 32 and cover 100. The injected foam layer 138 serves as a potting material and may be fire-resistant to further assist in inhibiting the rapid spread of fire in the case of thermal runaway of battery module 32. In some implementations, the injected foam layer 138 may comprise an injectable foam material such as a heat resistant lower thermal conductivity polyurethane foam.

In other implementations, injected foam layer 138 may be supplemented or replaced with a preformed panel of fire resistant or fire-retardant foam adhesively secured to or otherwise captured within cover 100, adjacent to an inner side or surface of cover 100. In some implementations, the injected foam 138 may be replaced with a fire retardant or fire-resistant foam or film that is sprayed onto or coated upon inner surfaces of cover 100. In some implementations, the preformed fire retardant or fire-resistant panel may be bonded before after shaping or folding of panel 120. In some implementations, the fire resistant or fire-retardant film or foam may be sprayed onto or coated upon surfaces of panel 120 prior to or after the shaping or bending of panel 120. In the example illustrated, cover 100 is encased by a fire-resistant expanded foam layer 140 that is applied over the outer surface of cover 100.

As further shown by FIG. 7, cover 100 may be further sprayed, coated or laminated with an outer layer 140 of a fire-resistant material. Layer 140 may be an expandable fire resistant or fire-retardant foam. Layer 140 may be a preformed panel which is bonded or otherwise held adjacent to the exterior of cover 100. Layer 140 may be a film or coding that is sprayed onto our coated upon the exterior surface of cover 100. The application of layer 140 to cover 100 may occur before or after the folding or shaping of panel 120 to form cover 100.

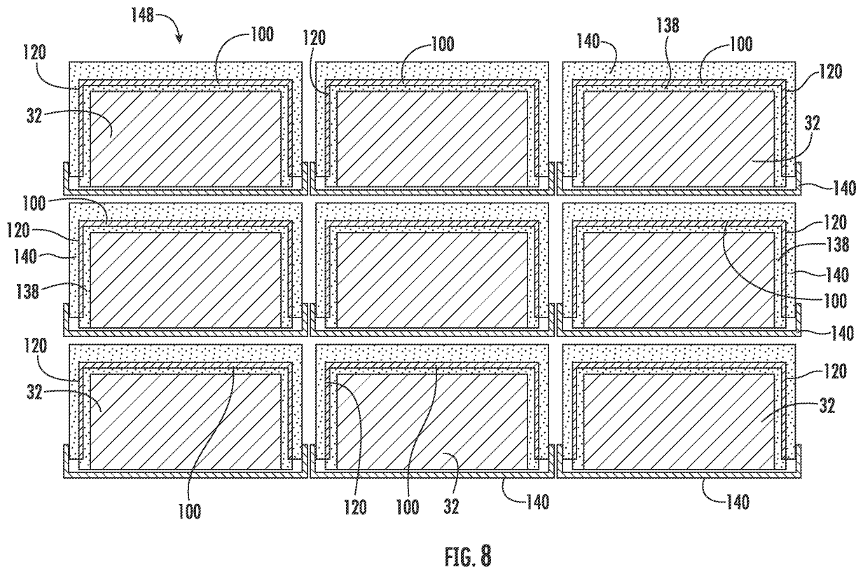

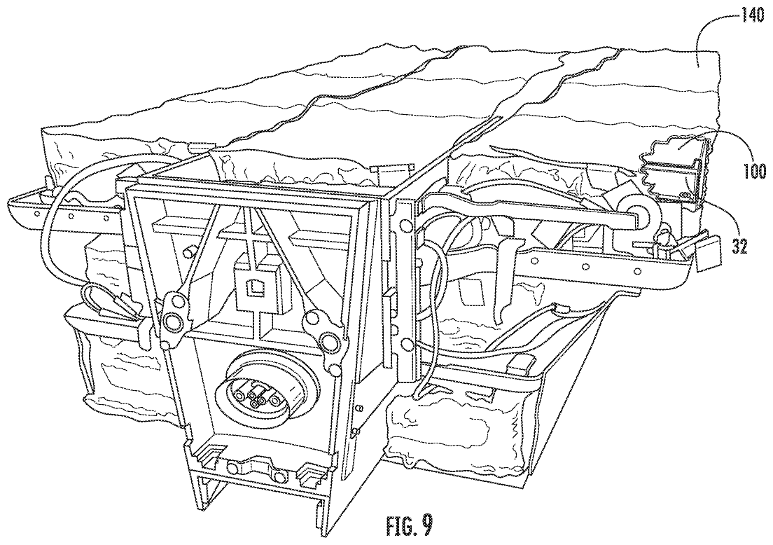

FIG. 8 is a sectional view through an example stacked bank of battery modules 32 with their associated covers 100 and fire-resistant foam layers 138 and 140. FIG. 9 is a perspective view of another example stack or bank of battery modules so as to form bank 30 discussed above with respect to FIG. 3 and contained by tractor 24. As shown by FIG. 9, each battery module along with its connection interface may be completely surrounded or encapsulated by the fire-resistant foam.

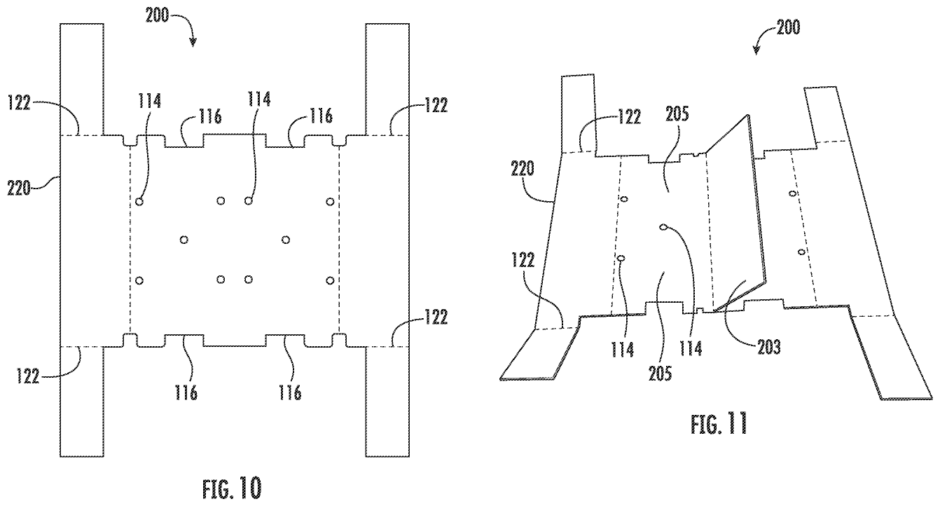

FIGS. 10-12 illustrate another example fire-resistant cover 200 that may use to cover battery modules. Cover 200 is similar to cover 100 except that cover 200 is configured to cover two battery modules. As shown by FIG. 11, cover 200 may include a downwardly extending flap or divider wall 203 which is located so as to extend between adjacent battery modules, between mutually opposing faces of side-by-side battery modules that are covered by the same cover 200. Divider wall 203 may be formed from a fire-resistant material. In some implementations, divider wall 203 is formed from the same fire-resistant material as that of the remainder of cover 200. As with cover 100, cover 200 may be formed from a mica, such as microparticles encapsulated within a resin or other fire-resistant materials having similar fire-resistant properties as discussed above with respect to cover 100. As with cover 100, cover 200 includes a multitude of fill ports 114 through its cover top 202. The sidewalls of cover 200 further form an opening 210 to provide access to a connection interface of each of the two enclosed modules 32. As with cover 100, cover 200 also includes notches or cut outs 116 to further provide access to a connection interface 134 of a received battery module 32. In other implementations, the exact location, size and shape of such openings 210 and cutouts 116 may vary depending upon the size and location of the connection interfaces of the battery modules 32.

In the example illustrated, cover 200 is formed from a single unitary body of a fire-resistant material. In the example illustrated, cover 200 comprises a single flat panel 220 bent to form the cover top 202 and the four cover sides 204. In some implementations, divider wall 204 is fused, welded, bonded or otherwise suspended from cover top 202. In some implementations, the divider wall 203 is secured to the cover top 202 by a UL 94 V rated flame retardant tape. In some implementations, both cover 100 and cover 200 are provided with a double-sided UL94 V rated tape 205 to secure cover 100 to the top of a battery module 32. In some implementations, such configuration may alternatively have a mechanical restraint to secure the cover 100, 200 to the module. For example, the mechanical constraint may comprise a firtree clip.

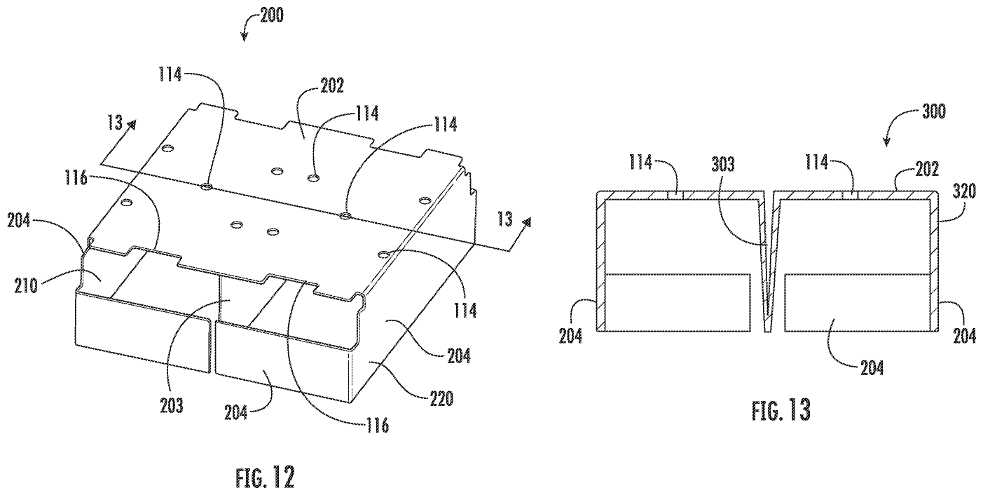

FIG. 13 illustrates an alternative cover 300 construction taken along line 13-13 of FIG. 12. Cover 300, including divider wall 303, is formed from a single substantially flat panel 320 of a fire-resistant material, such as mica. Divider wall 303 is formed by folding the flat panel 320 as shown. As with covers 100 and 200, cover 300 may include preformed creases to facilitate folding of the individual single panel of fire-resistant material. As with cover 200, cover 300 includes a multitude of fill ports 114 through its cover top 202. The sidewalls of cover 200 further form an opening 210 (shown in FIG. 12) to provide access to a connection interface of each of the two enclosed modules 32. As with cover 100, cover 200 also includes notches or cut outs 116 (shown in FIG. 12) to further provide access to a connection interface 134 of a received battery module 32. In other implementations, the exact location, size and shape of such openings 210 and cutouts 116 may vary depending upon the size and location of the connection interfaces of the battery modules 32. Although covers 200 and 300 are illustrated as being configured to cover two side-by-side battery modules 32, in other implementations, covers 200 and 300 may have other configurations so as to concurrently cover more than two battery modules.

In some implementations, covers 200 and 300 may be positioned over tray or pan, similar to the pan 140 described above. In some implementations, an expanding fire-resistant foam may be injected through fill ports 114 so as to substantially encapsulate the top and all four sides of each battery module 32 between battery modules 32 and covers 200 and 300 between battery modules 32 and the divider wall 203. In some implementations, covers 200 and 300 may further be encased within an outer layer of a fire-resistant material, such as a fire-resistant foam or an expanded fire-resistant foam similar to that shown in FIGS. 7 and 9.

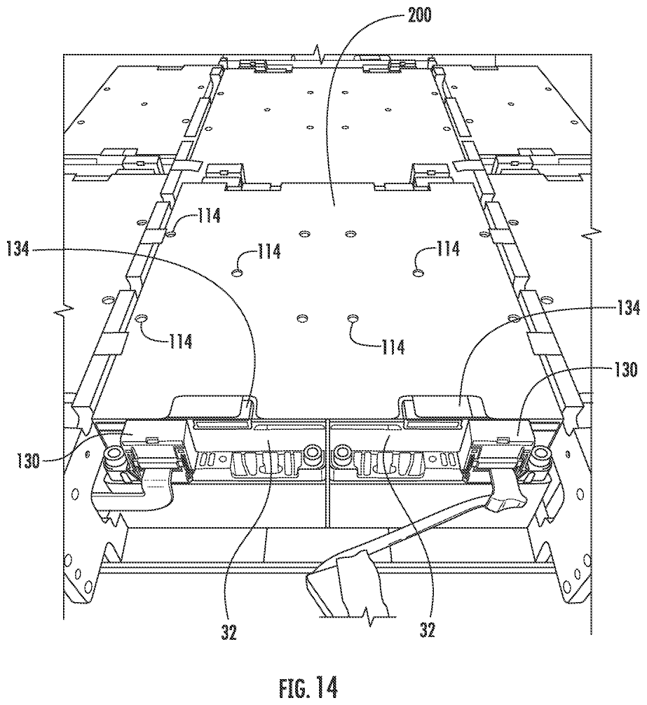

FIG. 14 illustrates a pair of battery modules 32 covered by cover 200 prior to the injection of the fire-retardant or fire-resistant foam through the fill ports 114.

Although the claims of the present disclosure are generally directed to a battery runaway management system comprising a battery module and a cover extending over a top and each side of the battery module, wherein the cover is integrally formed as a single unitary body from a fire-resistant or fire-retardant material, the present disclosure is additionally directed to the features set forth in the following definitions.
Definition 1. A battery runaway management system comprising:
   a battery module;
   a cover extending over a top and each side of the battery module, the cover being integrally formed as a single unitary body from a fire-resistant or fire-retardant material.
Definition 2. The system of Definition 1, wherein the fire-resistant or fire-retardant material comprises mica.
Definition 3. The system of Definition 1, wherein the cover comprises a single flat panel bent to form a cover top and four cover sides.
Definition 4. The system of Definition 3, wherein the panel comprises preformed creases about which the panel is bent and folded.
Definition 5. The system of Definition 1, wherein the fire-resistant or fire-retardant material comprises mica particles encapsulated within a resin.
Definition 6. The system of Definition 1, wherein the fire-resistant or fire-retardant material is configured to withstand a temperature of at least 750° C. for at least 10 minutes.
Definition 7. The system of Definition 1, wherein the fire-resistant or fire-retardant material is configured to withstand a temperature of 1200° C. for at least 10 minutes.
Definition 8. The system of Definition 1, wherein the cover comprises a cover sidewall having an opening through which a portion of the battery module projects, wherein the portion comprises a battery connection interface.
Definition 9. The system of Definition 1, wherein the cover comprises at least one fill port through which a fire-resistant expanding foam may be injected between the cover and the battery module.
Definition 10. The system of Definition 9 further comprising the fire-resistant foam extending between the cover and a top of the battery module.
Definition 11. The system of Definition 10, wherein the fire-resistant foam continuously extends from between the cover and the top of the battery module along a side of the battery module, between the side of the battery module and the cover.
Definition 12. The system of Definition 11, wherein the fire-resistant foam continuously extends from between the cover and the top of the battery module about all sides of the battery module, between the sides of the battery module and the cover.
Definition 13. The system of Definition 12, wherein a layer of fire-resistant foam extends over a top of the cover.
Definition 14. The system of Definition 13, wherein the layer of fire-resistant foam continuously extends from above the top of the cover along an outer side of the cover.
Definition 15. The system of Definition 14, wherein the layer of fire-resistant foam continuously extends from above the top of the cover and along all outer sides of the cover.
Definition 17. The system of Definition 15 further comprising a metallic pan underlying and supporting the fire-resistant module, wherein the fire-resistant foam extends into the pan about the battery module.
Definition 18. The system of any of the above Definitions further comprising:
   a second battery module; and
   a second cover extending over a top and each side of the second battery module, the second cover being integrally formed as a single unitary body from a fire-resistant material configured to withstand a temperature of 150° C. for at least 30 minutes.
Definition 19. The system of Definition 17 further comprising a metallic pan underlying the second battery module.
Definition 20. The system of Definition 17, wherein the second battery module overlies the cover.
Definition 21. The system of Definition 19, wherein a fire-resistant foam extends between a top of the cover and a bottom of the second battery module.
Definition 22. The system of Definition 19, wherein a fire-resistant layer extends between a top of the cover and a bottom of the second battery module.
Definition 23. The system of Definition 21 further comprising a metallic pan underlying the second battery module and a fire-resistant layer extending between the metallic pan and a top of the cover.
Definition 24. The system of Definition 17, wherein the second battery module extends alongside the first battery module.
Definition 25. The system of Definition 23, wherein portions of the cover and the first cover extend between the battery module and the second battery module.
Definition 27. A fire-resistant cover for a battery module, the fire-resistant cover comprising:
   a flat panel formed from a fire-resistant material, the flat panel being foldable to form a cover top and at least three cover sides configured to extend over and alongside portions of the battery module.
Definition 28. The cover of Definition 27, wherein the flat panel comprises at least one foam fill port through which a fire-resistant foam or potting may be injected into an interior of the cover.
Definition 29. The cover of definition 28, wherein the at least one foam fill port extends through a portion of the flat panel that is to form the cover top.
Definition 30. The cover of Definition 27, wherein the panel comprises a cutout such that when the panel is folded, an opening configured to receive a connection interface of the battery module is formed.
Definition 31. The cover of Definition 27, wherein the fire-resistant material comprises mica.
Definition 32. The cover of Definition 31, wherein the fire-resistant material comprises particles of the mica encapsulated within a resin.
Definition 33. The cover of Definition 27, wherein the flat panel comprises preformed creases along which the flat panel may be folded or bent to form the cover top and the cover sides.
Definition 34. The cover of Definition 27, wherein the fire-resistant material is configured to withstand a temperature of 150° C. for at least 30 minutes.
Definition 35. The cover of Definition 27, wherein the fire-resistant material is configured to withstand a temperature of at least 750° C. for at least 10 minutes.
Definition 36. The cover of Definition 27, wherein the fire-resistant material is configured to withstand a temperature of at least 1200° C. for at least 10 minutes.
Definition 37. A battery thermal runaway management system comprising:
   a first battery module;
   a second battery module alongside the first battery module;
   a cover extending over a top of the first battery module and the second battery module and along each of the non-mutually facing sides of the first battery module and the second battery module, the cover being integrally formed as a single unitary body from a fire-resistant material.
Definition 38. The system of Definition 37 further comprising a divider wall suspended from a cover top of the cover and extending between mutually face and sides of the first battery module and the second battery module, the divider wall being formed from a fire-resistant material.
Definition 39. The system of Definition 38, wherein the divider wall is bonded to the cover top.
Definition 40. The system of Definition 38, wherein the divider wall is integrally formed as part of a single unitary body with the cover.
Definition 41. The system of Definition 40, wherein the cover is formed from a folded or bent panel of fire-resistant material and wherein the divider wall is formed from a folded portion of the panel.
Definition 42. The system of Definition 41, wherein the fire-resistant material comprises mica.
Definition 43. The system of Definition 37, wherein the cover comprises a panel bent to form a cover top and cover sides.
Definition 44. The system of Definition 43, wherein the panel comprises preformed creases along which the panel is bent.
Definition 45. The system of Definition 37, wherein the cover is formed from a single homogenous flat panel of a fire-resistant material that is been to form a cover top and cover sides.
Definition 46. The system of Definition 37, wherein the cover comprises at least one first fill port above the first battery module and at least one second fill port above the second battery module.
Definition 47. The system of Definition 46 further comprising an expanded fire-resistant foam or potting injected through the least one first fill port and the least one second fill port and extending between the cover and the first battery module and the second battery module.
Definition 48. The system of Definition 47, wherein the expanded fire-resistant foam extends between mutually facing sides of the first battery module and the second battery module.
Definition 49. The system of Definition 37, wherein the cover comprises a first opening through which a connection interface of the first battery module is accessible and a second opening through which a connection interface of the second battery module is accessible.
Definition 50. The system of Definition 37 further comprising a layer of fire-resistant material extending over the cover and over each of the first battery module and the second battery module.
Definition 51. The system of Definition 50, wherein the layer comprises an expanded fire-resistant foam.
Definition 52. The system of Definition 51, wherein the layer continuously extends from over each of the first battery module and the second battery module along each side of each of the first battery module and the second battery module.
Definition 53. The system of Definition 37 further comprising metallic pan underlying the first battery module and the second battery module.
Definition 54. The system of Definition 37 further comprising:
   a third battery module overlying the first battery module; and
   a second cover extending over a top of the third battery module and along each side of the third battery module, the second cover being integrally formed as a single unitary body from a fire-resistant material.
Definition 55. The system of Definition 54 further comprising a fire-resistant foam extending over and directly upon the second cover.
Definition 56. The system of Definition 55, wherein the fire-resistant foam continuously extends along each cover side of the second cover.
Definition 57. The system of Definition 56 further comprising metallic pan underlying the third battery module and overlying the cover.
Definition 58. The system of Definition 54, wherein the fire-resistant material of the second cover comprises mica.
Definition 59. The system of Definition 54, wherein the second cover comprises a single flat panel of the fire-resistant material which has been folded to form a cover top and cover sides.
Definition 60. A battery runaway management system comprising:
   at least one battery module;
   a cover extending over a top and each side of the at least one battery module, the cover being integrally formed as a single unitary body from a fire-resistant or fire-retardant material.
Definition 61. The system of Definition 60, wherein the at least one battery module comprises a first battery module and a second battery module alongside the first battery module and wherein the system further comprises a divider wall suspended from a cover top of the cover and extending between mutually facing sides of the first battery module and the second battery module, the divider wall being formed from a fire-resistant or fire-retardant material.
Definition 62. The system of Definition 61, wherein the divider wall is bonded to the cover top.
Definition 63. The system of Definition 61, wherein the divider wall is integrally formed as part of a single unitary body with the cover.
Definition 64. The system of Definition 61, wherein the cover is formed from a folded or bent panel of fire-resistant material and wherein the divider wall is formed from a folded portion of the panel.

Although the present disclosure has been described with reference to example implementations, workers skilled in the art will recognize that changes may be made in form and detail without departing from the scope of the claimed subject matter. For example, although different example implementations may have been described as including features providing benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A battery runaway management system comprising:
at least one battery module;
a cover extending over a top and each side of the at least one battery module, the cover being integrally formed as a single unitary body from a fire-resistant or fire-retardant material.

2. The system of claim 1, wherein the fire-resistant or fire-retardant material comprises mica.

3. The system of claim 1, wherein the cover comprises a single flat panel bent to form a cover top and four cover sides.

4. The system of claim 3, wherein the panel comprises preformed creases about which the panel is bent and folded.

5. The system of claim 1, wherein the cover comprises a cover sidewall having an opening through which a portion of the at least one battery module projects, wherein the portion comprises a battery connection interface.

6. The system of claim 1, wherein the cover comprises at least one fill port through which a fire-resistant expanding foam may be injected between the cover and the at least one battery module.

7. The system of claim 6 further comprising the fire-resistant expanding foam extending between the cover and a top of the at least one battery module.

8. The system of claim 6 further comprising a metallic pan underlying and supporting the fire-resistant module, wherein the fire-resistant expanding foam extends into the pan about the at least one battery module.

9. The system of claim 1 further comprising:
a second battery module; and
a second cover extending over a top and each side of the second battery module, the second cover being integrally formed as a single unitary body from a fire-resistant material configured to withstand a temperature of 150° C. for at least 30 minutes.

10. The system of claim 9, wherein the second battery module overlies the cover.

11. The system of claim 10, wherein a fire-resistant layer extends between a top of the cover and a bottom of the second battery module.

12. The system of claim 1, wherein the at least one battery module comprises a first battery module and a second battery module alongside the first battery module and wherein the system further comprises a divider wall suspended from a cover top of the cover and extending between mutually facing sides of the first battery module and the second battery module, the divider wall being formed from a fire-resistant or fire retardant material.

13. The system of claim 12, wherein the divider wall is bonded to the cover top.

14. The system of claim 12, wherein the divider wall is integrally formed as part of a single unitary body with the cover.

15. The system of claim 12, wherein the cover is formed from a folded or bent panel of fire-resistant material and wherein the divider wall is formed from a folded portion of the panel.

16. A fire resistant cover for a battery module, the fire resistant cover comprising:
a flat panel formed from a fire resistant material, the flat panel being foldable to form a cover top and at least three cover sides configured to extend over and along side portions of the battery module.

17. The cover of claim 16, wherein the flat panel comprises at least one foam fill port through which a fire resistant foam or potting may be injected into an interior of the cover.

18. The cover of claim 17, wherein the at least one foam fill port extends through a portion of the flat panel that is to form the cover top.

19. A battery thermal runaway management system comprising:
a first battery module;
a second battery module alongside the first battery module;
a cover extending over a top of the first battery module and the second battery module and along each of the non-mutually facing sides of the first battery module and the second battery module, the cover being integrally formed as a single unitary body from a fire resistant material.

20. The system of claim 19 further comprising a divider wall suspended from a cover top of the cover and extending between mutually facing sides of the first battery module and the second battery module, the divider wall being formed from a fire resistant material.
